(19) United States
(12) Patent Application Publication
(10) Pub. No.: US 2026/0220701 A1
(43) Pub. Date: Jul. 30, 2026

(54) ARTIFICIAL INTELLIGENCE-BASED (AI-BASED) SYSTEM AND METHOD FOR DETERMINING FINANCIAL PRODUCTS USING DATA-DRIVEN FINANCIAL INSIGHTS

(71) Applicant: YamaPay Inc., Stockton, CA (US)

(72) Inventor: Ashraf R. Seddeek, Stockton, CA (US)

(21) Appl. No.: 19/040,900

(22) Filed: Jan. 30, 2025

(51) Int. Cl. G06Q 40/03; G06F 21/60; G06F 21/62

(52) U.S. Cl. CPC G06Q 40/03; G06F 21/602; G06F 21/6254

(57) ABSTRACT

An artificial intelligence-based (AI-based) method and system for determining financial products using data-driven financial insights are disclosed. The system obtains financial data using soft credit checks from financial data sources and lending criteria data from financial institutions to update a lender criteria database in real time. A data analysis subsystem performs comparative analysis using hybrid AI-based matching models to compute an odds score for matching financial products to the user. A match score generating subsystem evaluates the reliability of matches using confidence scores and generates a prioritized list of financial products. Additionally, a financial product utility optimization subsystem computes a Leave No Money (LNM) score for optimizing financial benefits across credit rewards, loan rates, and insurance. The system integrates user-generated feedback and sentiment analysis to enhance recommendations and enables automated financial decision-making based on predefined go-ahead conditions. Notifications and an interactive dashboard ensure user engagement and informed decision-making.

### TECHNICAL FIELD

Embodiments of the present disclosure relate to financial technology systems and more particularly relate to an artificial intelligence-based (AI-based) system and method for determining one or more financial products using one or more data-driven financial insights.

### BACKGROUND

In the financial industry, one or more users often face significant challenges in selecting and optimizing one or more financial products such as loans, credit cards, and insurance policies. Traditional systems primarily rely on static models or manual processes that fail to account for the dynamic nature and evolving nature of financial data, lender requirements, and user preferences. As a result, the one or more users often make suboptimal financial decisions, leading to higher interest rates, missed rewards, and inadequate insurance coverage.

Existing solutions lack real-time adaptability, frequently providing generic recommendations that do not consider frequent changes in user financial profiles, market conditions, and lender criteria. Additionally, the traditional systems are further limited by their inability to integrate user-generated feedback or community insights, which are essential for evaluating the suitability and performance of the one or more financial products. This lack of feedback mechanisms results in poor transparency and limited personalization in recommendation of the one or more financial products.

A significant drawback of existing systems is their reliance on hard credit checks, adversely affecting users'credit scores and discouraging them from exploring better financial options. Furthermore, most existing systems fail to deliver actionable insights or automated processes to optimize the one or more financial products on an ongoing basis. Opportunities such as refinancing loans, maximizing credit card rewards, or adjusting insurance policies often go unnoticed due to the absence of a proactive, data-driven approach.

Additionally, existing technologies rarely provide comprehensive metrics to evaluate the effective utilization of financial products. Users are left without tools to measure or improve their financial efficiency, leading to wasted opportunities for savings, rewards, and cost reductions. This highlights the need for a dynamic, intelligent system that adapts to user-specific data, integrates feedback, and provides actionable insights for continuous optimization of the one or more financial products.

In the existing technology, a computer-implemented system and method to manage the credit life cycle of a user in real-time are disclosed. The computer-implemented system also includes analyzing the data in the credit report of a user and assisting them in closing a pending account or rectifying an erroneous account. The computer-implemented system further includes modules to recommend a financial product suitable for the user depending on the criteria given by the associated financial institution. In another embodiment of the computer-implemented system, it helps in comparing the credit data of its previous credit report and newly obtained credit report and alerts the user with the changes incorporated therein. However, the computer-implemented system fails to provide real-time adaptability to changes in user financial profiles or lender criteria and does not integrate user-generated feedback or community-driven insights to enhance transparency and personalization. Additionally, the computer-implemented system relies heavily on hard credit checks, which negatively impact user credit scores, discouraging users from exploring better financial opportunities.

Therefore, there is a need for an intelligent, real-time, and user-focused system to address the aforementioned issues that dynamically adapts to changes in financial profiles, integrates reliable user feedback, provides personalized recommendations, and offers actionable insights to optimize the utility and cost-effectiveness of financial products

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence-based (AI-based) system and method for determining one or more financial products using one or more data-driven financial insights are disclosed.

In the first step, the AI-based method includes obtaining, by one or more hardware processors through a data-obtaining subsystem, financial data related to a user using one or more soft credit checks from one or more financial data sources. The one or more financial data sources comprise at least one of: one or more credit bureaus, one or more financial accounts associated with the user, income data, employment status, financial goals, lender organizations, and one or more user-generated feedback.

In an exemplary embodiment, the AI-based method includes masking, by the one or more hardware processors through a data masking module, the obtained financial data using one or more data masking techniques to anonymize personally identifiable information (PII), including at least one of: usernames, addresses, and unique identifiers, before performing the comparative analysis. In the next step, the AI-based method includes encrypting, by the one or more hardware processors through a data encryption subsystem, the obtained financial data using one or more cryptographic protocols to secure data management.

In the next step, the AI-based method includes obtaining, by the one or more hardware processors through the data-obtaining subsystem, lending criteria data associated with the one or more financial products from one or more financial institutions to update a lender criteria database in real-time. The lending criteria data comprises at least one of: one or more credit score thresholds, one or more debt-to-income (DTI) ratio limits, one or more interest rate ranges, one or more loan term options, and one or more risk tolerance thresholds.

In the next step, the AI-based method includes performing, by the one or more hardware processors through a data analysis subsystem, a comparative analysis between the financial data and the lending criteria data based on the one or more data-driven financial insights using one or more AI-based matching models. In an exemplary embodiment, performing the comparative analysis further comprises a) determining, by the one or more hardware processors through the data analysis subsystem, a weighted score for the financial data, comprises at least one of: credit score, debt-to-income (DTI) ratio, income level, credit utilization, and payment history, based on one of: predefined weights and dynamically adjusted weights, b) incorporating, by the one or more hardware processors through the data analysis subsystem, updated lending criteria data, into the comparative analysis, and c) updating, by the one or more hardware processors through the data analysis subsystem, the weighted score of the financial data dynamically based on at least one of: changes in user financial data, changes in the lending criteria data, and trends identified from the one or more user-generated feedback.

In an exemplary embodiment, the one or more AI-based matching models comprise a hybrid model, the hybrid model comprises: a) performing, by one or more decision trees, a rule-based matching of the financial data, the lending criteria data, and the one or more user-generated feedback, and b) regenerating, by a logistic regression model, the odds score by analyzing relationships between the financial data, the lending criteria data, and the one or more user-generated feedback.

In the next step, the AI-based method includes generating, by the one or more hardware processors through a match score generating subsystem, an odds score in real-time based on the comparative analysis to determine a potential match of the one or more financial products to the user based on the one or more data-driven financial insights. The one or more data-driven financial insights comprise at least one of: one or more credit checks, the one or more user-generated feedback, and automated execution of the user-authorized financial decisions.

In an exemplary embodiment, the match score generating subsystem comprises: a) computing, by a real-time scoring engine, the odds score based on a weighted comparison of the financial data and lending criteria data, b) generating, by a confidence scoring module, a confidence score representing a reliability of the odds score, based on factors including the completeness of user financial data, the availability of lender criteria, and historical matching accuracy data, c) recalibrating, by a dynamic weight recalibration module, the weights of the financial data and the update lending criteria data to update the odds score, d) generating, by a recommendation module, a prioritized list of the one or more financial products for the user, ranked according to the odds score and the one or more data-driven financial insights, and e) computing, by a financial product utility optimization subsystem, a Leave No Money (LNM) score based on at least one of: credit reward optimization metrics, loan rate efficiency metrics, insurance optimization metrics, and real-time dynamic adjustments of the one or more financial products to identify utility optimization of the one or more financial products by the user.

In the next step, the AI-based method includes analyzing, by the one or more hardware processors through a feedback analysis subsystem, the one or more user-generated feedback for the one or more financial products using at least: one or more artificial intelligence (AI) models and one or more machine learning (ML) models to determine at least one of: financial products trends and financial product insights. In an exemplary embodiment, at least: the one or more AI models and the one or more ML models include a sentiment analysis engine employing natural language processing (NLP) techniques to determine at least one of: the financial products trends and the financial product insights based on analyzing the one or more user-generated feedback.

In the next step, the AI-based method includes integrating, by the one or more hardware processors through the feedback analysis subsystem, the determined at least one of: the financial products trends and the financial product insights into the comparative analysis to optimize the determination of potential match of the one or more financial products to the user.

In the next step, the AI-based method includes executing, by the one or more hardware processors through an authorization subsystem, user-authorized financial decisions based on predefined go-ahead conditions to perform one or more user actions using the one or more data-driven financial insights. In an exemplary embodiment, the predefined go-ahead conditions comprise at least one of: approval odds exceeding a threshold score, interest rates within a predefined range, and community-driven feedback scores meeting user-specified benchmarks. The one or more user actions comprise at least one of: applying for loans, refinancing, consolidate existing financial portfolio, and switching the one or more financial products.

In the next step, the AI-based method includes notifying, by the one or more hardware processors through a notification subsystem, at least one of: the updated lending criteria data and the user-authorized financial decisions to the user by using one or more alert notifications. In the next step, the AI-based method includes displaying, by the one or more hardware processors through one or more communication devices, a dashboard summarizing at least one of: the financial data, the lending criteria data, the prioritized list of the one or more financial products, the odds score, and the one or more user-generated feedback.

According to another aspect of the present disclosure, the AI-based system for the one or more financial products matching using the one or more data-driven financial insights is disclosed. The AI-based system comprises one or more servers configured with one or more hardware processors and a memory unit. The memory unit is coupled to the one or more hardware processors, wherein the memory comprises a plurality of subsystems in form of programmable instructions executable by the one or more hardware processors. The plurality of subsystems comprises the data-obtaining subsystem, the data analysis subsystem, and the match score generating subsystem.

In an embodiment, the data-obtaining subsystem is configured to obtain the financial data related to the user using the one or more soft credit checks from the one or more financial data sources. The data-obtaining subsystem is configured to obtain the lending criteria data associated with the one or more financial products from the one or more financial institutions to update the lender criteria database in real time.

In an embodiment, the data analysis subsystem is configured to perform the comparative analysis between the financial data and the lending criteria data based on the one or more data-driven financial insights using the one or more AI-based matching models. In an embodiment, the match score generating subsystem is configured to generate the odds score in real-time based on the comparative analysis for determining the potential match of the one or more financial products to the user based on the one or more data-driven financial insights.

According to another aspect of the present disclosure, a non-transitory computer-readable storage medium storing computer-executable instructions that, when executed by one or more hardware processors, cause the one or more hardware processors to perform operations for determining one or more financial products using one or more data-driven financial insights. The operations comprise: a) obtaining the financial data related to the user using the one or more soft credit checks from the one or more financial data sources, b) obtaining the lending criteria data associated with the one or more financial products from the one or more financial institutions to update the lender criteria database in real-time, c) performing the comparative analysis between the financial data and the lending criteria data based on the one or more data-driven financial insights using the one or more AI-based matching models, d) generating the odds score in real-time based on the comparative analysis to determine a potential match of the one or more financial products to the user based on the one or more data-driven financial insights, e) analyzing the one or more user-generated feedback for the one or more financial products using at least: the one or more AI models and one or more ML models to determine at least one of: the financial products trends and the financial product insights, f) integrating the determined at least one of: the financial products trends and the financial product insights into the comparative analysis to optimize the identification of potential match of the one or more financial products to the user, and g) executing the user-authorized financial decisions based on predefined go-ahead conditions to perform the one or more user actions using the one or more data-driven financial insights.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture depicting an artificial intelligence-based (AI-based) system for determining one or more financial products using one or more data-driven financial insights, in accordance with an embodiment of the present disclosure;

FIG. 2A illustrates an exemplary block diagram representation of the AI-based system as shown in FIG. 1 for determining the one or more financial products using the one or more data-driven financial insights, in accordance with an embodiment of the present invention;

FIG. 2B illustrates an exemplary flow chart depicting a process for training a hybrid model for determining the one or more financial products using the one or more data-driven financial insights, in accordance with an embodiment of the present invention;

FIG. 3 illustrates an exemplary flowchart of an AI-based method for determining the one or more financial products using the one or more data-driven financial insights, in accordance with an embodiment of the present invention; and

FIG. 4 illustrates an exemplary block diagram representation of one or more server platforms for implementation of the disclosed AI-based system, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

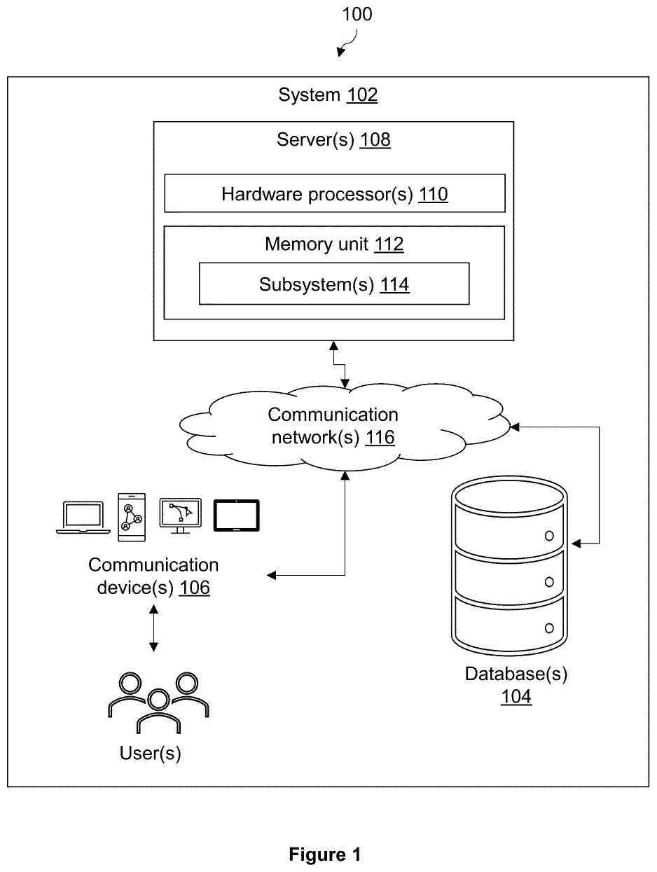

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 depicting an artificial intelligence-based (AI-based) system 102 for determining the one or more financial products using the one or more data-driven financial insights, in accordance with an embodiment of the present disclosure.

According to an exemplary embodiment of the present disclosure, FIG. 1 depicts the network architecture 100 may include the AI-based system 102, one or more databases 104, and one or more communication devices 106. The AI-based system 102 the one or more databases 104, and the one or more communication devices 106 may be communicatively coupled via one or more communication networks 116, ensuring seamless data transmission, processing, and decision-making. The AI-based system 102 acts as a central processing unit within the network architecture 100, responsible for determining the one or more financial products using the one or more data-driven financial insights. The AI-based system 102 is configured to execute a set of computer-readable instructions that control a plurality of subsystems 114.

In an exemplary embodiment, the AI-based system 102 comprises one or more hardware processors 110 and a memory unit 112. The memory unit 112 is operatively connected to the one or more hardware processors 110. The memory unit 112 comprises a set of computer-readable instructions in form of the plurality of subsystems 114, configured to be executed by the one or more hardware processors 110. In an exemplary embodiment, the AI-based system 102 comprises one or more servers 108. The one or more servers 108 may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or the one or more hardware processors 110.

In an exemplary embodiment, the one or more hardware processors 110 may include, for example, microprocessors, microcomputers, microcontrollers, digital signal processors, central processing units, state machines, logic circuits, and/or any devices that manipulate data or signals based on operational instructions. Among other capabilities, the one or more hardware processors 110 may fetch and execute computer-readable instructions in the memory unit 112 operationally coupled with the AI-based system 102 for performing tasks such as performing comparative analysis, input/output processing, and/or any other functions. Any reference to a task in the present disclosure may refer to an operation or that may be performed on the one or more financial products. The one or more hardware processors 110 are high-performance processors capable of handling large volumes of the one or more financial products and complex computations. The one or more hardware processors 110 may be, but not limited to, at least one of: multi-core central processing units (CPU), a graphics processing unit (GPU)-based processing unit, and the like that enhance an ability of the AI-based system 102 to determine the one or more financial products using the one or more data-driven financial insights.

In an exemplary embodiment, the one or more databases 104 may configured to store and manage data related to various aspects of the AI-based system 102. The one or more databases 104 may store at least one of, but not limited to, financial data, lending criteria data, one or more user-generated feedback, one or more data-driven financial insights, historical matching data, security data, dynamic adjustment data, leave no money (LNM) score metrics, and the like. The one or more databases 104 serve as a centralized repository for critical data elements that are integral to the secure operation of the AI-based system 102, enabling efficient management and synchronization of data associated with the AI-based system 102. The one or more databases 104 enable the AI-based system 102 to dynamically retrieve, analyze, and update the stored financial data and the lending criteria data in real-time, for determining the one or more financial products using the one or more data-driven financial insights. The one or more databases 104 may include different types of databases such as, but not limited to, relational databases (e.g., Structured Query Language (SQL) databases), non-Structured Query Language (NoSQL) databases (e.g., MongoDB, Cassandra), time-series databases (e.g., InfluxDB), an OpenSearch database, object storage systems, lender criteria database, and the like.

In an exemplary embodiment, the one or more communication devices 106 are configured to enable a user to interact with the AI-based system 102. The one or more communication devices 106 may be digital devices, computing devices, and/or networks. The one or more communication devices 106 may include, but not limited to, a mobile device, a smartphone, a personal digital assistant (PDA), a tablet computer, a phablet computer, a wearable computing device, a virtual reality/augmented reality (VR/AR) device, a laptop, a desktop, and the like. The one or more communication devices 106 are configured with a user interface configured to enable seamless interaction between the one or more users and the AI-based system 102. The user interface may include the graphical user interface (GUI) units, voice-based interfaces, and touch-based interfaces, depending on the capabilities of the AI-based system 102 being used. The GUI units may be configured to display outputs, including at least one of: financial data summary, product recommendations, a prioritized list of the one or more financial products for the user, scores and metrics, trend insights, actionable notifications, interactive dashboards, authorization controls, and the like. The one or more communication devices 106 may also support multimodal inputs, allowing users to interact through voice commands, text inputs, or gesture-based controls, ensuring accessibility and ease of use across different user demographics. The one or more communication devices 106 are configured to securely transmit and receive data to and from the AI-based system 102 via one or more communication networks, ensuring seamless user experience and real-time synchronization.

In an exemplary embodiment, the one or more communication networks 116 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fibre optic network, a satellite network, a cloud computing network, a combination of networks, and the like. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth®, ZigBee®, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the AI-based system 102 may be implemented by way of a single device or a combination of multiple devices that may be operatively connected or networked together. The AI-based system 102 may be implemented in hardware or a suitable combination of hardware and software.

Though few components and the plurality of subsystems 114 are disclosed in FIG. 1, there may be additional components and subsystems which is not shown, such as, but not limited to, ports, routers, repeaters, firewall devices, network devices, the one or more databases 104, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the AI-based system 102, and the one or more communication devices 106 connected to the one or more databases 104, one skilled in the art may envision that the AI-based system 102, and the one or more communication devices 106 may be connected to several user devices located at various locations and several databases via the one or more communication networks 116.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the AI-based system 102 as is unique to the present disclosure or necessary for an understanding of the present disclosure is depicted and described. The remainder of the construction and operation of the AI-based system 102 may conform to any of the various current implementations and practices that were known in the art.

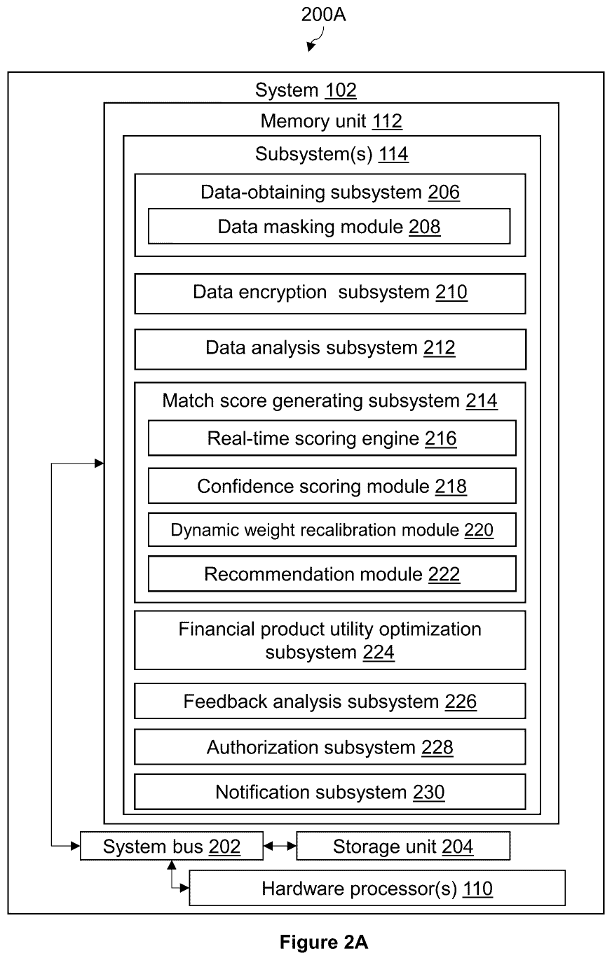

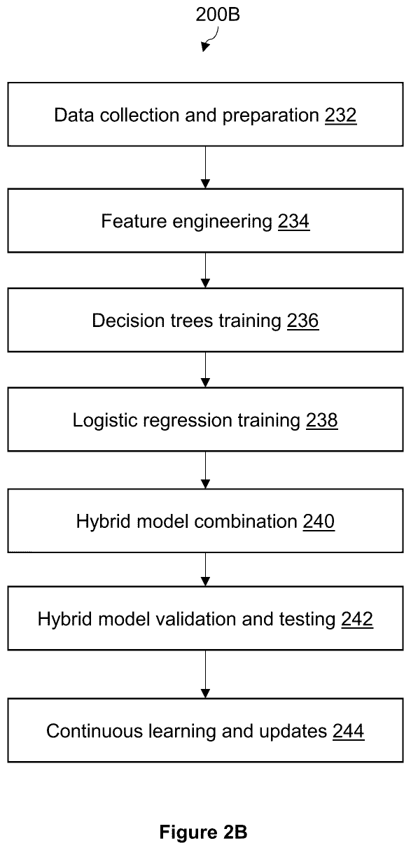

FIG. 2A illustrates an exemplary block diagram representation 200A of the AI-based system as shown in FIG. 1 for determining the one or more financial products using the one or more data-driven financial insights, in accordance with an embodiment of the present invention.

FIG. 2B illustrates an exemplary flow chart 200B depicting a process for training a hybrid model for determining the one or more financial products using the one or more data-driven financial insights, in accordance with an embodiment of the present invention.

In an exemplary embodiment, the AI-based system 102 (hereinafter referred to as the system 102) comprises the one or more servers 108, the memory unit 112, and a storage unit 204. The one or more hardware processors 110, the memory unit 112, and the storage unit 204 are communicatively coupled through a system bus 202 or any similar mechanism. The system bus 202 functions as the central conduit for data transfer and communication between the one or more hardware processors 110, the memory unit 112, and the storage unit 204. The system bus 202 facilitates the efficient exchange of information and instructions, enabling the coordinated operation of the system 102. The system bus 202 may be implemented using various technologies, including but not limited to, parallel buses, serial buses, and high-speed data transfer interfaces such as, but not limited to, at least one of a: universal serial bus (USB), peripheral component interconnect express (PCIe), and similar standards.

In an exemplary embodiment, the memory unit 112 is operatively connected to the one or more hardware processors 110. The memory unit 112 comprises the plurality of subsystems 114 in the form of programmable instructions executable by the one or more hardware processors 110. The plurality of subsystems 114 comprises a data-obtaining subsystem 206, a data encryption subsystem 210, a data analysis subsystem 212, a match score generating subsystem 214, a financial product utility optimization subsystem 224, a feedback analysis subsystem 226, an authorization subsystem 228, and a notification subsystem 230. The one or more hardware processors 110, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory unit 112 may be the non-transitory volatile memory and the non-volatile memory. The memory unit 112 may be coupled to communicate with the one or more hardware processors 110, such as being a computer-readable storage medium. The one or more hardware processors 110 may execute machine-readable instructions and/or source code stored in the memory unit 112. A variety of machine-readable instructions may be stored in and accessed from the memory unit 112. The memory unit 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 112 includes the plurality of subsystems 114 stored in the form of machine-readable instructions on any of the above-mentioned storage media and may be in communication with and executed by the one or more hardware processors 110.

The storage unit 204 may be a cloud storage or the one or more databases 104 such as those shown in FIG. 1. The storage unit 204 may store, but not limited to, recommended course of action sequences dynamically generated by the system 102. The action sequences comprise the prioritized list of the one or more financial products for the user, optimization instructions, historical data, real-time updates, LNM score metrics, user preferences and conditions, sentiment and feedback analysis results, system performance logs, and the like. The storage unit 204 is structured to enable efficient retrieval and management of large datasets and dynamic action sequences. The storage unit 204 supports real-time synchronization with the plurality of subsystems 114 and ensures that the recommendations and action sequences remain accurate and up-to-date. Additionally, the storage unit 204 may retain previous action sequences for comparison and future reference, enabling continuous refinement of the system 102 over time. The storage unit 204 may be any kind of database such as, but not limited to, relational databases, dedicated databases, dynamic databases, monetized databases, scalable databases, cloud databases, distributed databases, any other databases, and a combination thereof.

Furthermore, the storage unit 204 may integrate with external systems, such as credit bureau systems, lender systems, banking and financial accounts, insurance providers, community feedback platforms, regulatory and compliance systems, cloud computing platforms, payment gateways and transaction systems, ai model training systems, and the like. These integrations ensure that the storage unit 204 remains a central repository for managing data essential to the AI-based system 102, enabling dynamic, real-time updates, seamless data flow, and actionable insights for the one or more financial products optimization. This interconnected architecture supports the system's adaptability, scalability, and ability to deliver personalized and accurate recommendations to the user.

In an exemplary embodiment, the data-obtaining subsystem 206 is configured to obtain the financial data related to the user using the one or more soft credit checks from the one or more financial data sources. The one or more financial data sources comprise at least one of: one or more credit bureaus, one or more financial accounts associated with the user, income data, employment status, financial goals, lender organizations, and the one or more user-generated feedback. The data-obtaining subsystem 206 ensures a comprehensive understanding of the user's financial profile by consolidating data from diverse and reliable sources. The data-obtaining subsystem 206 is configured to perform the one or more soft credit checks to retrieve the financial data without negatively impacting the user's credit score, allowing the user to explore the one or more financial products freely. By accessing the diverse financial data sources the data-obtaining subsystem 206 creates a holistic financial profile of the user.

Further, the data-obtaining subsystem 206 is configured to obtain the lending criteria data associated with the one or more financial products from the one or more financial institutions to update the lender criteria database in real-time. The lending criteria data is updated dynamically as the one or more financial institutions modify at least one of: thresholds, interest rates, loan terms, and the like, ensuring the system 102 provides recommendations based on the most current information. The lending criteria data comprises at least one of: one or more credit score thresholds, one or more debt-to-income (DTI) ratio limits, one or more interest rate ranges, one or more loan term options, and one or more risk tolerance thresholds. The data-obtaining subsystem 206 incorporates user-generated feedback into the data collection process, enabling the system to evaluate financial products based on community insights and user satisfaction metrics.

The data-obtaining subsystem 206 is configured with a data masking module 208. The data masking module 208 is configured to obtain the financial data using one or more data masking techniques to anonymize personally identifiable information (PII), including at least one of: usernames, addresses, and unique identifiers, before performing the comparative analysis. The data masking module 208 ensures that PII is anonymized during data processing, reducing the risk of data breaches and ensuring compliance with legal standards. By integrating data from multiple sources and anonymizing sensitive information, the data-obtaining subsystem 206 ensures seamless, secure, and efficient data processing, enabling the AI-based system 102 to deliver optimized financial product recommendations tailored to the user's unique financial profile.

In an exemplary embodiment, the data encryption subsystem 210 is operatively connected to the data-obtaining subsystem 206. The data encryption subsystem 210 is configured to encrypt the obtained financial data using one or more cryptographic protocols to secure data management. The encryption ensures the confidentiality, integrity, and security of sensitive financial data throughout the data processing pipeline. The data encryption subsystem 210 is configured to perform encryption both at rest and in transit to safeguard data against unauthorized access and potential breaches. The one or more cryptographic protocols comprise but not limited to: Advanced Encryption Standard (AES) 256-bit, secure sockets layer (SSL) and transport layer security (TLS) protocols, and the like. The AES 256-bit protocol is used for encrypting the financial data at rest to provide robust security against data breaches. The AES 256-bit protocol ensures that sensitive information, such as the financial data obtained from credit bureaus, financial accounts, and user profiles, remains secure in storage. The SSL/TLS protocols utilized for encrypting the financial data in transit to ensure secure communication between the data-obtaining subsystem 206, the one or more databases 104, and external systems, such as the one or more credit bureaus and the one or more financial institutions.

The data encryption subsystem 210 is configured to ensures that financial data is encrypted from the point of retrieval by the data-obtaining subsystem 206 to the point of storage in the one or more databases 104 or transmission to other components of the system 102. The data encryption subsystem 210 is configured for key management to implement secure key generation, storage, and rotation policies. Encryption keys are securely managed to prevent unauthorized decryption of sensitive data. The data encryption subsystem 210 is configured to provide a role-based access control (RBAC). The RBAC is configured to limit access to the encrypted financial data based on user roles and system permissions, ensuring that only authorized processes or the plurality of subsystems 114 may decrypt and access the financial data. The data encryption subsystem 210 is configured to integrate tamper detection mechanism to detect any unauthorized modifications to the encrypted financial data, ensuring the financial data integrity during storage or transmission. The data encryption subsystem 210 operates seamlessly with the data masking module 208 to anonymize PII before encryption, further reducing risks associated with sensitive data exposure.

In an exemplary embodiment, the data analysis subsystem 212 is configured to perform a comparative analysis between the financial data and the lending criteria data based on the one or more data-driven financial insights using one or more AI-based matching models. The comparative analysis enables the system 102 to identify potential matches between the user's financial profile and the one or more financial products offered by the one or more financial institutions, ensuring highly accurate and personalized recommendations.

The data analysis subsystem 212 is configured to determine a weighted score for the financial data, which comprises at least one of: credit score, debt-to-income (DTI) ratio, income level, credit utilization, and payment history. These factors are weighted based on one of: predefined weights and dynamically adjusted weights. The predefined weights are established based on general industry standards and rules, while dynamically adjusted weights adapt to changes in at least one of: the user's financial data, lending criteria data, and emerging trends identified from user-generated feedback. A custom “odds adjustment engine” recalibrates weightings dynamically, prioritizing recent financial improvements. The odds adjustment engine ensures that recent financial improvements in a user's profile are prioritized during the computation of the odds score, enabling more accurate and up-to-date financial product recommendations.

The odds adjustment engine dynamically adjusts the weights of financial data parameters, such as credit score, debt-to-income (DTI) ratio, income level, credit utilization, and payment history. For instance, if the user demonstrates a significant improvement in their credit score or a reduction in their credit utilization, the odds adjustment engine recalibrates the weightings to reflect these changes, ensuring they are given greater importance during the comparative analysis.

The data analysis subsystem 212 is further configured to incorporate updated lending criteria data into the comparative analysis. The lending criteria data comprises at least one of: one or more credit score thresholds, one or more DTI ratio limits, one or more interest rate ranges, one or more loan term options, and one or more risk tolerance thresholds. By integrating the most current lending criteria data, the data analysis subsystem 212 ensures that recommendations align with the real-time requirements and offerings of the one or more financial institutions.

The data analysis subsystem 212 is configured to update the weighted score of the financial data dynamically based on at least one of: changes in user financial data, changes in the lending criteria data, and trends identified from the one or more user-generated feedback. The changes in user financial data includes at least one of: updates to credit score, payment history, income, and credit utilization. The changes in the lending criteria data accounts for modifications to at least one of, but not limited to, lender-specific thresholds, interest rates, risk parameters, and the like. The trends identified from the one or more user-generated feedback such as factors in community-driven insights or sentiment trends about financial products to refine recommendations and enhance user relevance.

The one or more AI-based matching models comprise a hybrid model, the hybrid model. The hybrid model comprises at least one of, but not limited to, one or more decision trees, logistic regression model, and the like. The hybrid model performs rule-based matching using the one or more decision trees. The one or more decision trees analyze the financial data, the lending criteria data, and the one or more user-generated feedback to identify matches based on predefined rules. For instance, the one or more decision trees may evaluate whether the user's credit score meets the lender's minimum threshold or whether the user's debt-to-income ratio satisfies the lender's risk tolerance limits. The hybrid model employs the logistic regression model to compute probabilities and relationships between the financial data and the lending criteria data. The logistic regression model analyzes complex patterns in the data to generate an odds score representing the likelihood of approval for a specific financial product of the one or more financial products.

In an exemplary embodiment, the hybrid model used by the data analysis subsystem 212 is trained using a combination of supervised machine learning techniques and domain-specific rule sets to ensure accurate financial product matching. The hybrid model integrates decision trees for rule-based matching and logistic regression for probabilistic analysis, creating a robust framework for analyzing the financial data and the lending criteria data. At step 232, the training of the hybrid model includes inputting a training dataset including a large volume of historical financial data, lending criteria data, and user-generated feedback into the hybrid model. This data is sourced from at least one of, but not limited to, the credit bureaus for historical credit reports, payment history, and credit utilization trends, the one or more lender databases for lending criteria, including thresholds for credit scores, DTI ratios, and interest rates, the user interactions, including past one or more financial products matches, approval outcomes, and feedback on one or more financial products performance, and community-driven insights, such as sentiment scores and feedback trends for the one or more financial products. The training dataset is cleaned, anonymized using the data masking module 208, and preprocessed to remove outliers and inconsistencies.

At step 234, the training of the hybrid model includes extracting key features from the prepared from the prepared dataset. The extracted key features comprise at least one of, but not limited to, user financial features: credit score, DTI ratio, income, credit utilization, and payment history, lending criteria features: minimum credit score, maximum DTI ratio, interest rate ranges, and risk tolerance thresholds, feedback features. The key features are normalized and encoded to ensure compatibility with the hybrid model's training.

At step 236, the training of the hybrid model includes training the one or more decision trees to create rule-based structures that map user financial data to lending criteria. The training process involves a) Identifying thresholds for each feature (e.g., minimum credit score or maximum DTI ratio) based on lender requirements, b) Splitting the dataset iteratively into branches to optimize decision paths, minimizing impurity (e.g., Gini index or entropy) at each step, and c) Pruning the one or more decision trees to avoid overfitting and ensure generalizability across diverse user profiles.

At step 238, the training of the hybrid model includes training the logistic regression model to compute an odds score, representing the probability of the one or more financial products being a suitable match for the user. The training process involves a) assigning weights to each feature based on its contribution to product approval or rejection, b) using a labeled dataset where matches and non-matches are classified, the logistic regression model learns to predict probabilities by minimizing error through gradient descent, c) regularization techniques, such as L1 regularization (Lasso Regression) or L2 regularization (Ridge Regression), are applied to prevent overfitting and enhance model robustness.

At step 240, the hybrid model integrates the outputs of the one or more decision trees and the logistic regression model: a) The one or more decision trees provide rule-based filtering, ensuring that only the one or more financial products meeting core eligibility criteria are considered, b) The logistic regression model further analyzes the filtered results to compute the odds score and rank the one or more financial products based on their likelihood of approval, and c) The integration process is fine-tuned using ensemble learning techniques, such as stacking or weighted averaging, to improve overall hybrid model performance.

At step 242, the trained hybrid model is validated and tested using a separate dataset to evaluate its accuracy, precision, recall, and overall performance. Metrics such as the area under the receiver operating characteristic curve (AUC-ROC) and harmonic mean score are used to assess its predictive capabilities. One or more feedback loops from real-world user interactions are incorporated to continuously refine the hybrid model. Further, at step 244, the hybrid model is continuously retrained using new data from real-time user interactions and updated lending criteria. The one or more feedback from users, including successful matches and approval outcomes, is integrated into the training pipeline to enhance hybrid model accuracy and adaptability over time.

In an exemplary embodiment, the match score generating subsystem 214 is configured to generate the odds score in real-time based on the comparative analysis for determining a potential match of the one or more financial products to the user based on the one or more data-driven financial insights. The one or more data-driven financial insights comprise at least one of: one or more credit checks, the one or more user-generated feedback, and automated execution of the user-authorized financial decisions.

The match score generating subsystem 214 is configured with a real-time scoring engine 216. The real-time scoring engine 216 is configured to compute the odds score by performing a weighted comparison of the financial data and the lending criteria data. The financial data includes key metrics such as, but not limited to, at least one of: the user's credit score, DTI ratio, income level, credit utilization, and payment history. The lending criteria data comprises, but not limited to, at least one of: thresholds, limits, and preferences provided by financial institutions, including credit score minimums, interest rate ranges, loan terms, risk tolerance thresholds, and the like. The weighted comparison ensures that the odds score reflects the likelihood of a successful match between the user's financial profile and the specific financial product criteria. The scoring engine operates in real time, dynamically recalculating the odds score as updates to the user's financial data or the lending criteria data are incorporated.

The match score generating subsystem 214 is configured with a confidence scoring module 218. The confidence scoring module 218 is configured to generates a confidence score representing the reliability of the calculated odds score. The confidence score is based on factors such as, but not limited to, at least one of: the completeness of user financial data, the availability of lender criteria, historical matching accuracy data, and the like. The confidence scoring module 218 is configured to evaluates whether all critical financial metrics (e.g., credit score, DTI ratio) are available or if missing data could impact the accuracy of the odds score. The confidence scoring module 218 is configured to assesses whether sufficient lender criteria are present to make a robust comparison. The confidence scoring module 218 is configured to analyze past performance of the system's recommendations to gauge how accurately similar matches were predicted. The confidence score provides users with transparency into the robustness of the odds score and enables informed decision-making.

The match score generating subsystem 214 is configured with a dynamic weight recalibration module 220. The dynamic weight recalibration module 220 is configured to adjust the weights of the financial data and the updated lending criteria data in real time. This ensures that the odds score remains accurate and reflective of: changes in user financial data, changes in lending criteria, trends from user-generated feedback, and the like. For example, an improvement in the user's credit score may increase their odds of qualifying for certain financial products within the one or more financial products. The match score generating subsystem 214 is configured check updates in lender thresholds, such as a reduction in minimum credit score requirements, are immediately factored into the recalibration. Further, the community-driven insights, such as increasing user satisfaction with a particular product, influence the recalibration to improve personalization. This dynamic adjustment process ensures that the scoring mechanism is adaptable and remains aligned with real-time changes.

The match score generating subsystem 214 is configured with a recommendation module 222. The recommendation module 222 is configured to generate a prioritized list of the one or more financial products for the user. The prioritized list is ranked based on the calculated odds score and the one or more data-driven financial insights. The ranking considers factors such as the likelihood of approval, financial benefits (e.g., lower interest rates, higher rewards), and user preferences. The recommendation module 222 presents the prioritized recommendations in a user-friendly format, enabling users to compare options and make informed decisions. The recommendations are updated dynamically as the user's financial profile or market conditions evolve.

In an exemplary embodiment, the financial product utility optimization subsystem 224 is configured to compute a Leave No Money (LNM) score to identify the utility optimization of the one or more financial products by the user. The LNM score is based on, but not limited to, at least one of: credit reward optimization metrics, loan rate efficiency metrics, insurance optimization metrics, real-time dynamic adjustments of the one or more financial products, and the like, to identify utility optimization of the one or more financial products by the user. The LNM score represents a comprehensive measure of how effectively the user may utilize the one or more financial products. The financial product utility optimization subsystem 224 is configured to analyzes the user's spending patterns and credit card reward structures (credit reward optimization metrics) to determine opportunities for maximizing benefits, such as cashback, points, and travel rewards. The financial product utility optimization subsystem 224 is configured to identify underperforming credit cards and recommends alternatives to better align with the user's spending habits.

The financial product utility optimization subsystem 224 is configured to compute the LNM score based on the insurance optimization metrics. The financial product utility optimization subsystem 224 is configured to evaluate the interest rates and repayment terms of the user's existing loans (e.g., personal loans, mortgages). Which identifies refinancing opportunities or better loan options with reduced interest rates or more favorable terms. The financial product utility optimization subsystem 224 is configured to compute the LNM score based on the real-time dynamic adjustments of the one or more financial products. The financial product utility optimization subsystem 224 is configured to assess the user's existing insurance policies, including coverage details, premiums, and benefits. Recommends adjustments or alternative policies to reduce costs while maintaining or enhancing coverage. Further, update the LNM score dynamically as changes occur in one of: the user's financial data, lender criteria, and financial product offerings. This ensures that recommendations remain accurate and actionable over time.

The credit card optimization metrics includes but not limited to, at least one of: reward rate maximization, sign-up bonus utilization, annual fee efficiency, and spending alignment with credit card benefits. The loan rate efficiency metrics includes at least one of: comparison of current loan interest rates with market rates, refinancing opportunities, and optimization of loan terms and rate types. The insurance optimization metrics includes at least one of: premium-to-coverage ratio analysis, claims benefit utilization, and savings from multi-policy discounts or provider comparisons. The financial product utility optimization subsystem 224 is configured to monitor the one or more financial product opportunities in real-time to identify suboptimal product usage or missed benefits. The financial product utility optimization subsystem 224 is configured to recommend personalized financial actions to improve the user's LNM score, including one of: pre-authorized product switches, loan refinancing, and insurance adjustments. Further, the financial product utility optimization subsystem 224 is configured to track the financial impact of implemented recommendations, including at least one of: monthly or annual savings, reduced interest payments, optimized premiums, and increased rewards utilization.

In an exemplary embodiment, the financial product utility optimization subsystem 224 is configured to provide weights to at least one of: credit reward optimization metrics (35% weight), loan rate efficiency metrics (35% weight), insurance optimization metrics (30% weight), real-time dynamic adjustments of the one or more financial products, and the like. The high LNM score (for instance, 900+), indicates the user is effectively optimizing the one or more financial products, capturing rewards, and minimizing costs. If the LNM score is low (for instance, 500 or below), reflects missed financial opportunities, such as overpaying on loans, underutilizing credit card rewards, or holding expensive insurance policies. The score adjusts dynamically based on real-time financial data, user activity, and market conditions (e.g., new product offerings, interest rate changes).

In an exemplary embodiment, the feedback analysis subsystem 226 is configured to analyze the one or more user-generated feedback for the one or more financial products using at least: one or more artificial intelligence (AI) models and one or more machine learning (ML) models. The analysis is configured to determine at least one of: financial products trends and financial product insights, which are subsequently utilized to enhance the system's recommendations and decision-making capabilities.

The feedback analysis subsystem 226 is configured to incorporate user experiences and community-driven insights into the recommendation process, ensuring that the system 102 adapts to real-world financial product performance and user satisfaction metrics. The feedback analysis subsystem 226 is configured with at least one of: the one or more AI models and the one or more ML models include a sentiment analysis engine. The sentiment analysis engine utilizes natural language processing (NLP) techniques to extract sentiments from the one or more user-generated feedback. The one or more user-generated feedback such as, but not limited to, at least one of: reviews, ratings, and comments is processed to determine user sentiment, whether positive, negative, or neutral, about the one or more financial products. For example, feedback on a credit card may highlight user satisfaction with cashback rewards or dissatisfaction with annual fees.

At least one of: the one or more AI models and the one or more ML models are configured to identify trends such as popular financial products, emerging user preferences, and shifting market dynamics. The financial product insights are derived from aggregated feedback to evaluate the performance, usability, and suitability of the one or more financial products across various user demographics. The feedback analysis subsystem 226 identifies patterns, such as the one or more financial products performing well within a particular income group or region, and highlights those as recommendations. The feedback analysis subsystem 226 uses NLP-driven topic modeling to identify key themes in feedback, such as interest rates, rewards, fees, or customer service. The feedback analysis subsystem 226 extracts features are categorized and weighted to contribute to the comparative analysis of the one or more financial products.

The feedback analysis subsystem 226 is configured to integrate the determined at least one of: the financial products trends and the financial product insights into the comparative analysis performed by the data analysis subsystem 212. The integration enables the system to optimize the determination of potential match of the one or more financial products to the user. Incorporate real-world user satisfaction and sentiment data to improve the ranking and prioritization of the one or more financial products. The feedback analysis subsystem 226 is configured to adjust the one or more recommendations to align with user preferences and community-driven insights, ensuring greater relevance. The feedback analysis subsystem 226 is configured to update the comparative analysis dynamically as new feedback is collected, reflecting the latest trends and user perceptions of the one or more financial products.

The feedback analysis subsystem 226 operates in real-time to ensure that user-generated feedback is continuously analyzed and integrated into the system's recommendations. As new feedback is received, the feedback analysis subsystem 226 recalculates trends and insights, ensuring that the recommendations remain current. The feedback analysis subsystem 226 employs at least one of: the one or more AI models and the one or more ML models to validate the authenticity and relevance of user-generated feedback, filtering out spam or irrelevant data. The community-driven recommendations highlights the one or more financial products with consistently positive sentiment or high user satisfaction scores, reinforcing user confidence in the recommendations.

In an exemplary embodiment, the NLP techniques such as, but not limited to, at least one of: Bidirectional Encoder Representations from Transformers (BERT) or Generative Pre-Trained Transformers (GPT), for analyzing and extracting meaningful insights from textual feedback. The feedback analysis subsystem 226 ensures that the system 102 is not only data-driven but also user-centric, enabling it to provide actionable, transparent, and highly personalized one or more financial product recommendations.

In an exemplary embodiment, the authorization subsystem 228 is configured to execute user-authorized financial decisions based on predefined go-ahead conditions to perform one or more user actions using the one or more data-driven financial insights. The authorization subsystem 228 is configured to enable automated, secure, and efficient decision-making by ensuring that all actions are aligned with the user's predefined criteria and preferences. The predefined go-ahead conditions act as triggers that authorize the authorization subsystem 228 to proceed with executing specific financial decisions. The predefined go-ahead conditions comprise, but not limited to, at least one of: approval odds exceeding a threshold score, interest rates within a predefined range, and community-driven feedback scores meeting user-specified benchmarks.

The authorization subsystem 228 is configured to evaluate the odds score generated by the match score generating subsystem 214. If the calculated odds score surpasses the user-defined threshold, the authorization subsystem 228 considers the one or more financial products as eligible for further action. For example, the user may specify a minimum approval odds threshold of 80% for applying to a loan product. The authorization subsystem 228 checks whether the interest rates of a recommended financial product of the one or more financial products fall within the user-specified range. For instance, if the user sets a preference for loans with interest rates below 5%, only those products meeting this criterion are authorized for action. The authorization subsystem 228 incorporates feedback analysis data from the feedback analysis subsystem 226 to assess community-driven ratings or satisfaction scores. The one or more financial products are authorized for action only if their feedback scores meet or exceed the user-defined benchmark, ensuring alignment with user expectations and community trends. The predefined go-ahead conditions provide users with control and flexibility in automating financial decisions, ensuring that all actions are tailored to their individual financial goals and risk tolerance.

The authorization subsystem 228 facilitates the execution of one or more user actions once the predefined go-ahead conditions are satisfied. The one or more user actions comprise, but not limited to, at least one of: applying for loans, refinancing, consolidate existing financial portfolio, and switching the one or more financial products. The authorization subsystem 228 automatically initiates loan applications on behalf of the user, ensuring that all required information is submitted accurately. The authorization subsystem 228 uses the data obtained and analyzed by the plurality of subsystems 114 to streamline the application process. The authorization subsystem 228 is configured to identify opportunities for refinancing existing loans based on lower interest rates or more favorable terms. The authorization subsystem 228 automatically submits refinancing requests to lenders, optimizing the user's debt management strategy.

The authorization subsystem 228 is configured to recommend and execute consolidation of the one or more financial products, such as combining credit card balances or loans, into a single account with better terms. The one or more user actions simplifies financial management and reduces overall costs for the user. The authorization subsystem 228 is configured to automate the process of transitioning to better-performing one or more financial products, such as switching to a higher-reward credit card, refinancing a mortgage, or replacing insurance policies. The authorization subsystem 228 is configured to ensure minimal disruption to the user while maximizing financial benefits.

The authorization subsystem 228 is configured with robust security mechanisms to ensure that user-authorized decisions are executed safely. The authorization subsystem 228 is configured with Multi-Factor Authentication (MFA) that verifies user identity before executing sensitive actions, such as applying for loans or switching financial products. The authorization subsystem 228 is configured with audit logging that maintains a detailed record of all actions taken, including timestamps and the criteria that triggered the decisions. The authorization subsystem 228 is configured to allow the user to manually review or cancel automated actions if desired, ensuring flexibility and control. The authorization subsystem 228 ensures seamless, user-centric automation of financial decisions, leveraging data-driven insights to optimize the user's financial portfolio while maintaining full user control and transparency.

In an exemplary embodiment, the notification subsystem 230 is configured to notify the user about critical updates and actions related to the one or more financial products matching process. The notification subsystem 230 ensures timely communication of essential information, enabling users to stay informed and make data-driven financial decisions. The notification subsystem 230 utilizes one or more alert notifications to deliver updates to the user. The one or more alert notifications are provided to inform the user about at least one of: the updated lending criteria data and the user-authorized financial decisions. The one or more alert notifications are sent through various channels to ensure accessibility and usability across different devices and platforms. The key notification mechanisms include, but not limited to, at least one of: email alerts, push notifications, in-app notifications, short message service (SMS) alerts, and the like. Each alert notification of the one or more alert notifications includes clear, actionable information, ensuring that the user is able to easily understand the update and, if needed, take additional steps. The notification subsystem 230 is configured to allow the user to choose to receive one or more alert notifications in real time, daily summaries, or periodic updates. The notification subsystem 230 is configured to allow the user to select the types of updates they wish to receive, such as lending criteria changes, financial decisions, and general insights. The notification subsystem 230 is configured to allow the user specify their preferred channels, such as email, push notifications, and SMS.

In an exemplary embodiment, the one or more communication devices 106 are configured to display a user-friendly dashboard. The dashboard provides a comprehensive summary of the financial product matching process and other relevant insights. The information displayed includes, but is not limited to, the financial data, the lending criteria data, the prioritized list of the one or more financial products, the odds score, and the one or more user-generated feedback. The dashboard is configured with an intuitive GUI, enabling seamless interaction. The user is able to view updates, analyze insights, and make informed decisions with minimal effort.

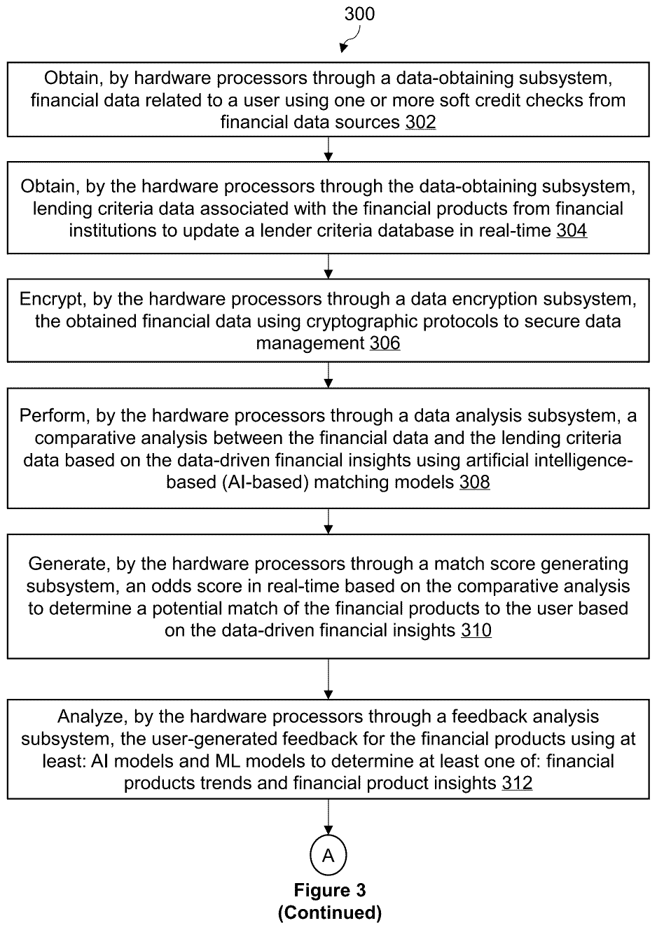

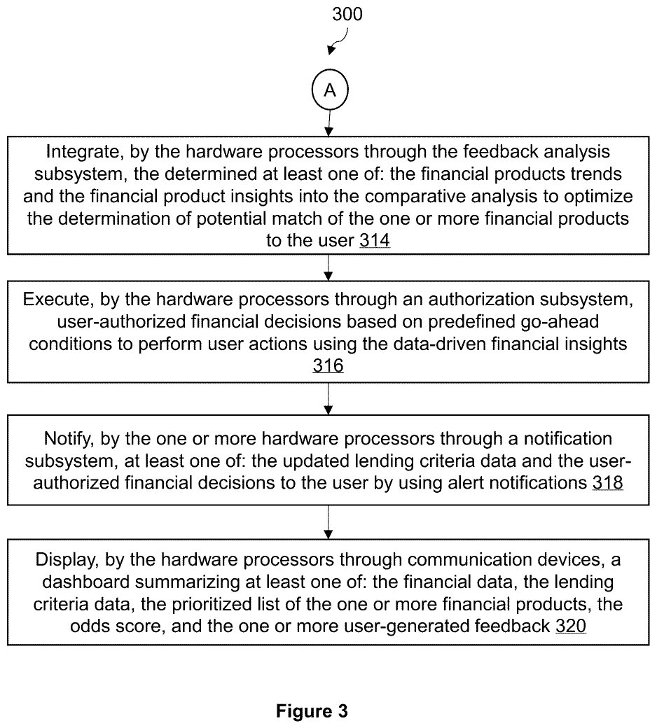

FIG. 3 illustrates an exemplary flowchart of an AI-based method 300 for determining the one or more financial products using the one or more data-driven financial insights, in accordance with an embodiment of the present invention.

At step 302, the AI-based method 300 includes the data-obtaining subsystem obtains the financial data related to the user using the one or more soft credit checks from the one or more financial data sources. The one or more financial data sources comprise at least one of: the one or more credit bureaus, the one or more financial accounts associated with the user, the income data, the employment status, the financial goals, the lender organizations, the one or more user-generated feedback. The data masking module masks the obtained financial data using the one or more data masking techniques to anonymize the PII, including at least one of: the usernames, the addresses, and the unique identifiers, before performing the comparative analysis.

At step 304, the AI-based method 300 includes the data-obtaining subsystem that obtains lending criteria data associated with the one or more financial products from the one or more financial institutions to update the lender criteria database in real-time. The lending criteria data comprises at least one of: the one or more credit score thresholds, the one or more DTI ratio limits, the one or more interest rate ranges, the one or more loan term options, and the one or more risk tolerance thresholds.

At step 306, the AI-based method 300 includes the data encryption subsystem that encrypts the obtained financial data using the one or more cryptographic protocols to secure data management.

At step 308, the AI-based method 300 includes the data analysis subsystem performs the comparative analysis between the financial data and the lending criteria data based on the one or more data-driven financial insights using one or more AI-based matching models. The comparative analysis further comprises a) determine the weighted score for the financial data, comprises at least one of: the credit score, the DTI ratio, the income level, credit utilization, and the payment history, based on one of: the predefined weights and the dynamically adjusted weights, b) incorporate the updated lending criteria data into the comparative analysis, and c) update the weighted score of the financial data dynamically based on at least one of: the changes in user financial data, the changes in the lending criteria data, and the trends identified from the one or more user-generated feedback. The one or more AI-based matching models comprise the hybrid model, the hybrid model is configured to perform the rule-based matching of the financial data, the lending criteria data, and the one or more user-generated feedback, using the one or more decision trees, and b) the hybrid model is configured to regenerate by the logistic regression model the odds score by analyzing relationships between the financial data, the lending criteria data, and the one or more user-generated feedback.

At step 310, the AI-based method 300 includes the match score generating subsystem generates the odds score in real-time based on the comparative analysis to determine the potential match of the one or more financial products to the user based on the one or more data-driven financial insights. The one or more data-driven financial insights comprise at least one of: the one or more credit checks, the one or more user-generated feedback, and the automated execution of the user-authorized financial decisions.

The match score generating subsystem comprises: a) the real-time scoring engine computes the odds score based on the weighted comparison of the financial data and the lending criteria data, b) the confidence scoring module generates the confidence score representing the reliability of the odds score, based on factors including the completeness of user financial data, the availability of lender criteria, and the historical matching accuracy data, c) the dynamic weight recalibration module recalibrate the weights of the financial data and the update lending criteria data to update the odds score, d) the recommendation module generates the prioritized list of the one or more financial products for the user, ranked according to the odds score and the one or more data-driven financial insights, and e) the financial product utility optimization subsystem computes the LNM score based on at least one of: the credit reward optimization metrics, the loan rate efficiency metrics, the insurance optimization metrics, and the real-time dynamic adjustments of the one or more financial products to identify utility optimization of the one or more financial products by the user.

At step 312, the AI-based method 300 includes the feedback analysis subsystem the analyzes the one or more user-generated feedback for the one or more financial products using at least: the one or more AI models and one or more ML models to determine at least one of: the financial products trends and the financial product insights. In an exemplary embodiment, at least: the one or more AI models and the one or more ML models include the sentiment analysis engine employing NLP techniques to determine at least one of: the financial products trends and the financial product insights based on analyzing the one or more user-generated feedback.

At step 314, the AI-based method 300 includes the feedback analysis subsystem integrates the determined at least one of: the financial products trends and the financial product insights into the comparative analysis to optimize the determination of potential match of the one or more financial products to the user.

At step 316, the AI-based method 300 includes the authorization subsystem executes the user-authorized financial decisions based on the predefined go-ahead conditions to perform the one or more user actions using the one or more data-driven financial insights. The predefined go-ahead conditions comprise at least one of: the approval odds exceeding the threshold score, the interest rates within the predefined range, and the community-driven feedback scores meeting user-specified benchmarks. The one or more user actions comprise at least one of: applying for loans, refinancing, consolidate existing financial portfolio, and switching the one or more financial products.

At step 318, the AI-based method 300 includes the notification subsystem notify at least one of: the updated lending criteria data and the user-authorized financial decisions to the user by using the one or more alert notifications. At step 320, the AI-based method 300 includes the one or more communication devices displays the dashboard summarizing at least one of: the financial data, the lending criteria data, the prioritized list of the one or more financial products, the odds score, and the one or more user-generated feedback.

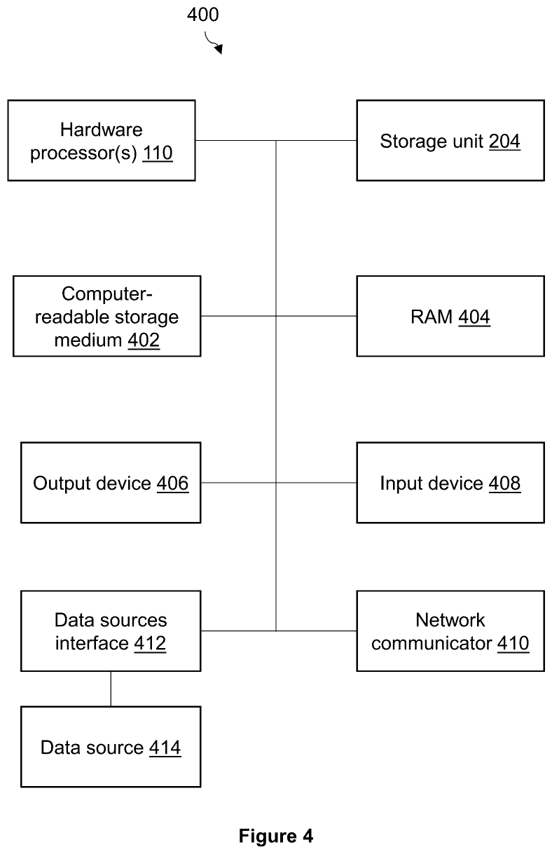

FIG. 4 illustrates an exemplary block diagram representation of one or more server platforms 400 for implementation of the disclosed AI-based system 102, in accordance with an embodiment of the present disclosure.

In an exemplary embodiment, for the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the one or more server platforms 900. As illustrated, the one or more server platforms 400 may include additional components not shown, and some of the components described may be removed and/or modified. For example, a computer system with the multiple graphics processing units (GPUs) may be located on at least one of: internal printed circuit boards (PCBs) and external-cloud platforms including Amazon® Web Services (AWS), Google® Cloud Platform (GCP) Microsoft® Azure (Azure), internal corporate cloud computing clusters, or organizational computing resources.

The one or more server platforms 400 may be a computer system such as the system 102 that may be used with the embodiments described herein. The computer system may represent a computational platform that includes components that may be in the one or more servers 108 or another computer system. The computer system may be executed by the one or more hardware processors 110 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the one or more hardware processors 110 that execute software instructions or code stored on a non-transitory computer-readable storage medium 402 to perform methods of the present disclosure. The software code includes, for example, instructions to gather data and analyze the network environment data. For example, the plurality of subsystems 114 includes the data-obtaining subsystem 206, the data encryption subsystem 210, the data analysis subsystem 212, the match score generating subsystem 214, the financial product utility optimization subsystem 224, the feedback analysis subsystem 226, the authorization subsystem 228, and the notification subsystem 230.

The instructions on the computer-readable storage medium 402 are read and stored the instructions in the storage unit or random-access memory (RAM) 404. The storage unit 204 may provide a space for keeping static data where at least some instructions could be stored for later execution. The stored instructions may be further compiled to generate other representations of the instructions and dynamically stored in the RAM 404. The one or more hardware processors 110 may read instructions from the RAM 404 and perform actions as instructed.

The computer system may further include an output device 406 to provide at least some of the results of the execution as output including, but not limited to, visual information of the determined and optimized the one or more financial products. The output device 406 may include a display on computing devices and virtual reality glasses. For example, the display may be a mobile phone screen or a laptop screen. Graphical user interfaces (GUIs) and/or text may be presented as an output on the display screen. The computer system may further include an input device 408 to provide the one or more users or another device with mechanisms for entering data and/or otherwise interacting with the computer system. The input device 408 may include, for example, a keyboard, a keypad, a mouse, or a touchscreen. Each of the output devices 406 and the input device 408 may be joined by one or more additional peripherals.

A network communicator 410 may be provided to connect the computer system to a network and in turn to other devices connected to the network including other entities, servers, data stores, and interfaces. The network communicator 410 may include, for example, a network adapter such as a LAN adapter or a wireless adapter. The computer system may include a data sources interface 412 to access a data source 414. The data source 414 may be an information resource about the one or more financial products. As an example, the one or more databases 104 of exceptions and rules may be provided as the data source 414. Moreover, knowledge repositories and curated data may be other examples of the data source 414. The data source 414 may include libraries containing, but not limited to, credit reports and creditworthiness metrics, lending criteria, market trends, user-generated feedback, historical matching records, community insights and recommendations, knowledge repositories, and the like. Additionally, the data source 414 may encompass information repositories and curated data sets that are critical for enabling the system 102 to determine the one or more financial products using the one or more data-driven financial insights.

Numerous advantages of the present disclosure may be apparent from the discussion above. In accordance with the present disclosure, the AI-based system for determining the one or more financial products using one or more data-driven financial insights. The AI-based system integrates real-time updates from the financial data sources and the lending criteria databases, ensuring that recommendations are always current and reflective of the latest user financial profiles and market conditions. The dynamic weight recalibration module within the system ensures adaptability to evolving user data, lender criteria, and community-driven feedback trends.

The use of the hybrid AI model combining decision trees for rule-based matching and logistic regression for odds score computation improves the precision of financial product matching. By leveraging both the historical and the real-time data, the system achieves higher matching accuracy, reducing the likelihood of recommending suboptimal financial products.

The system employs robust data masking techniques to anonymize PII, ensuring user privacy during the processing of sensitive financial data. The inclusion of the data encryption subsystem ensures secure management of financial data, protecting it from unauthorized access and breaches. The system integrates multiple data sources, including credit bureaus, financial accounts, income data, and user-generated feedback, to deliver holistic and personalized financial insights. The feedback analysis subsystem employs sentiment analysis and NLP techniques to derive actionable insights from the one or more user-generated feedback, enhancing transparency and user confidence.

The financial product utility optimization subsystem computes the LNM score to ensure users maximize financial benefits while minimizing costs. The system provides targeted recommendations for optimizing credit card rewards, loan rates, and insurance policies, enhancing financial efficiency across the user's portfolio. The authorization subsystem enables automated execution of user-authorized financial decisions based on predefined go-ahead conditions, such as approval odds thresholds, interest rate ranges, and feedback scores. This automation reduces manual effort and ensures timely actions, such as loan applications, refinancing, and portfolio consolidation. By incorporating user feedback and community-driven insights into the matching process, the system enhances the transparency of its recommendations. Features such as confidence scoring and audit logging provide users with clear visibility into the reliability and accuracy of the system's decisions. The system identifies and notifies users about opportunities for financial optimization, such as switching to better products, consolidating debt, or refinancing loans. Proactive alerts and insights ensure users can capture financial benefits without extensive manual effort.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. An artificial intelligence-based (AI-based) method for determining one or more financial products using one or more data-driven financial insights, the artificial intelligence-based (AI-based) method comprising:
obtaining, by one or more hardware processors through a data-obtaining subsystem, financial data related to a user using one or more soft credit checks from one or more financial data sources;
obtaining, by the one or more hardware processors through the data-obtaining subsystem, lending criteria data associated with the one or more financial products from one or more financial institutions to update a lender criteria database in real-time;
performing, by the one or more hardware processors through a data analysis subsystem, a comparative analysis between the financial data and the lending criteria data based on the one or more data-driven financial insights using one or more artificial intelligence-based (AI-based) matching models; and
generating, by the one or more hardware processors through a match score generating subsystem, an odds score in real-time based on the comparative analysis to determine a potential match of the one or more financial products to the user based on the one or more data-driven financial insights.

2. The artificial intelligence-based (AI-based) method of claim 1, wherein the one or more financial data sources comprise at least one of: one or more credit bureaus, one or more financial accounts associated with the user, income data, employment status, financial goals, lender organizations, and one or more user-generated feedback.

3. The artificial intelligence-based (AI-based) method of claim 1, wherein the lending criteria data comprises at least one of: one or more credit score thresholds, one or more debt-to-income (DTI) ratio limits, one or more interest rate ranges, one or more loan term options, and one or more risk tolerance thresholds.

4. The artificial intelligence-based (AI-based) method of claim 1, further comprises:
masking, by the one or more hardware processors through a data masking module, the obtained financial data using one or more data masking techniques to anonymize personally identifiable information (PII), including at least one of: usernames, addresses, and unique identifiers, before performing the comparative analysis; and
encrypting, by the one or more hardware processors through a data encryption subsystem, the obtained financial data using one or more cryptographic protocols to secure data management.

5. The artificial intelligence-based (AI-based) method of claim 1, wherein performing the comparative analysis further comprises:
determining, by the one or more hardware processors through the data analysis subsystem, a weighted score for the financial data, comprises at least one of: credit score, debt-to-income (DTI) ratio, income level, credit utilization, and payment history, based on one of: predefined weights and dynamically adjusted weights;
incorporating, by the one or more hardware processors through the data analysis subsystem, updated lending criteria data, into the comparative analysis; and
updating, by the one or more hardware processors through the data analysis subsystem, the weighted score of the financial data dynamically based on at least one of: changes in user financial data, changes in the lending criteria data, and trends identified from the one or more user-generated feedback.

6. The artificial intelligence-based (AI-based) method of claim 1, wherein the one or more artificial intelligence-based (AI-based) matching models comprise a hybrid model, the hybrid model comprises:
performing, by one or more decision trees, a rule-based matching of the financial data, the lending criteria data, and the one or more user-generated feedback; and
regenerating, by a logistic regression model, the odds score by analyzing relationships between the financial data, the lending criteria data, and the one or more user-generated feedback.

7. The artificial intelligence-based (AI-based) method of claim 1, wherein the match score generating subsystem comprises:
computing, by a real-time scoring engine, the odds score based on a weighted comparison of the financial data and lending criteria data;
generating, by a confidence scoring module, a confidence score representing a reliability of the odds score, based on factors including the completeness of user financial data, the availability of lender criteria, and historical matching accuracy data;
recalibrating, by a dynamic weight recalibration module, the weights of the financial data and the update lending criteria data to update the odds score;
generating, by a recommendation module, a prioritized list of the one or more financial products for the user, ranked according to the odds score and the one or more data-driven financial insights; and
computing, by a financial product utility optimization subsystem, a Leave No Money (LNM) score based on at least one of: credit reward optimization metrics, loan rate efficiency metrics, insurance optimization metrics, and real-time dynamic adjustments of the one or more financial products to identify utility optimization of the one or more financial products by the user.

8. The artificial intelligence-based (AI-based) method of claim 1, further comprising:
analyzing, by the one or more hardware processors through a feedback analysis subsystem, the one or more user-generated feedback for the one or more financial products using at least: one or more artificial intelligence (AI) models and one or more machine learning (ML) models to determine at least one of: financial products trends and financial product insights;
integrating, by the one or more hardware processors through the feedback analysis subsystem, the determined at least one of: the financial products trends and the financial product insights into the comparative analysis to optimize the determination of potential match of the one or more financial products to the user; and
executing, by the one or more hardware processors through an authorization subsystem, user-authorized financial decisions based on predefined go-ahead conditions to perform one or more user actions using the one or more data-driven financial insights.

9. The artificial intelligence-based (AI-based) method of claim 8, wherein at least: the one or more artificial intelligence (AI) models and the one or more machine learning (ML) models include a sentiment analysis engine employing natural language processing (NLP) techniques to determine at least one of: the financial products trends and the financial product insights based on analyzing the one or more user-generated feedback.

10. The artificial intelligence-based (AI-based) method of claim 8, wherein the predefined go-ahead conditions comprise at least one of: approval odds exceeding a threshold score, interest rates within a predefined range, and community-driven feedback scores meeting user-specified benchmarks.

11. The artificial intelligence-based (AI-based) method of claim 8, wherein the one or more user actions comprise at least one of: applying for loans, refinancing, consolidate existing financial portfolio, and switching the one or more financial products.

12. The artificial intelligence-based (AI-based) method of claim 1, further comprises:
notifying, by the one or more hardware processors through a notification subsystem, at least one of: the updated lending criteria data and the user-authorized financial decisions to the user by using one or more alert notifications; and
displaying, by the one or more hardware processors through one or more communication devices, a dashboard summarizing at least one of: the financial data, the lending criteria data, the prioritized list of the one or more financial products, the odds score, and the one or more user-generated feedback.

13. The artificial intelligence-based (AI-based) method of claim 1, wherein the one or more data-driven financial insights comprise at least one of: one or more credit checks, the one or more user-generated feedback, and automated execution of the user-authorized financial decisions.

14. An artificial intelligence-based (AI-based) system for determining one or more financial products using one or more data-driven financial insights, the artificial intelligence-based (AI-based) system comprising:
one or more servers, comprising:
one or more hardware processors; and
a memory unit coupled to the one or more hardware processors, wherein the memory comprises a plurality of subsystems in form of programmable instructions executable by the one or more hardware processors, and wherein the plurality of subsystems comprises:
a data-obtaining subsystem configured to:
obtain financial data related to a user using one or more soft credit checks from one or more financial data sources; and
obtain lending criteria data associated with the one or more financial products from one or more financial institutions to update a lender criteria database in real time;
a data analysis subsystem configured to perform a comparative analysis between the financial data and the lending criteria data based on the one or more data-driven financial insights using one or more artificial intelligence-based (AI-based) matching models; and
a match score generating subsystem configured to generate an odds score in real-time based on the comparative analysis for determining a potential match of the one or more financial products to the user based on the one or more data-driven financial insights.

15. The artificial intelligence-based (AI-based) system of claim 14, further comprises:
a data masking module is configured to mask the obtained financial data using one or more data masking techniques to anonymize personally identifiable information (PII), including at least one of: usernames, addresses, and unique identifiers, before performing the comparative analysis; and
a data encryption subsystem is configured to encrypt the obtained financial data using one or more cryptographic protocols to secure data management.

16. The artificial intelligence-based (AI-based) system of claim 14, wherein the data analysis subsystem is configured to:
assign weights to the financial data, comprises at least one of: credit score, debt-to-income (DTI) ratio, income level, credit utilization, and payment history, based on one of: predefined weights and dynamically adjusted weights;
incorporate the update lending criteria data, into the comparative analysis; and
update the weights of the financial data dynamically based on at least one of:
changes in user financial data, changes in the lending criteria data, and trends identified from the one or more user-generated feedback.

17. The artificial intelligence-based (AI-based) system of claim 14, wherein the one or more artificial intelligence-based (AI-based) matching models comprise a hybrid model,
the hybrid model comprises at least one of: one or more decision trees and a logistic regression model, configured to at least one of:
perform a rule-based matching of the financial data the lending criteria data, and the one or more user-generated feedback; and
regenerate the odds score by analyzing relationships between the financial data, the lending criteria data, and the one or more user-generated feedback.

18. The artificial intelligence-based (AI-based) system of claim 14, wherein the match score generating subsystem comprises:
a real-time scoring engine is configured to compute the odds score based on a weighted comparison of the financial data and lending criteria data;
a confidence scoring module is configured to generate a confidence score representing a reliability of the odds score, based on factors including a completeness of user financial data, the availability of lender criteria, and historical matching accuracy data;
a dynamic weight recalibration module is configured to recalibrate the weights of the financial data and the updated lending criteria data to update the odds score;
a recommendation module is configured to generate a prioritized list of the one or more financial products for the user, ranked according to the odds score and the one or more data-driven financial insights; and
a financial product utility optimization subsystem configured to compute a Leave No Money (LNM) score based on at least one of: credit reward optimization metrics, loan rate efficiency metrics, insurance optimization metrics, and real-time dynamic adjustments of the one or more financial products for identifying utility optimization of the one or more financial products by the user.

19. The artificial intelligence-based (AI-based) system of claim 14, further comprising:
a feedback analysis subsystem configured to:
analyze the one or more user-generated feedback for the one or more financial products using at least: one or more artificial intelligence (AI) models and one or more machine learning (ML) models to determine at least one of: financial products trends and financial product insights; and
integrate the determined at least one of: the financial products trends and the financial product insights into the comparative analysis to optimize the determination of potential match of the one or more financial products to the user; and
an authorization subsystem is configured to execute user-authorized financial decisions based on predefined go-ahead conditions to perform one or more user actions,
the predefined go-ahead conditions comprise at least one of: approval odds exceeding a threshold score, interest rates within a predefined range, and community-driven feedback scores meeting user-specified benchmarks; and
the one or more user actions comprise at least one of: applying for loans, refinancing, consolidate existing financial portfolio, and switching the one or more financial products.

20. A non-transitory computer-readable storage medium storing computer-executable instructions that, when executed by one or more hardware processors, cause the one or more hardware processors to perform operations for determining one or more financial products using one or more data-driven financial insights, the operations comprising:
obtaining financial data related to a user using one or more soft credit checks from one or more financial data sources;
obtaining lending criteria data associated with the one or more financial products from one or more financial institutions to update a lender criteria database in real time;
performing a comparative analysis between the financial data and the lending criteria data based on the one or more data-driven financial insights using one or more artificial intelligence-based (AI-based) matching models; and
generating an odds score in real-time based on the comparative analysis to determine a potential match of the one or more financial products to the user based on the one or more data-driven financial insights;
analyzing the one or more user-generated feedback for the one or more financial products using at least: one or more artificial intelligence (AI) models and one or more machine learning (ML) models to determine at least one of: financial products trends and financial product insights;
integrating the determined at least one of: the financial products trends and the financial product insights into the comparative analysis to optimize the identification of potential match of the one or more financial products to the user; and
executing user-authorized financial decisions based on predefined go-ahead conditions to perform one or more user actions using the one or more data-driven financial insights.
